(19) United States
(12) Patent Application Publication
(10) Pub. No.: US 2017/0172136 A1
(43) Pub. Date: Jun. 22, 2017

(54) Animal Deterring Device

(71) Applicant: Carl LaRue, Cambridge, OH (US)

(72) Inventor: Carl LaRue, Cambridge, OH (US)

(21) Appl. No.: 15/154,244

(22) Filed: May 13, 2016

Related U.S. Application Data
(60) Provisional application No. 62/269,144, filed on Dec. 18, 2015.

(51) Int. Cl. A01M 29/10; H04N 7/18; A01M 29/16

(52) U.S. Cl. CPC A01M 29/10; A01M 29/16; H04N 7/188

(57) ABSTRACT

An animal deterring device for use in keeping wild animals away from a specific area. The animal deterring device includes a housing having a motion detector thereon that is configured to detect the presence of an animal in the vicinity thereof. The motion detector is part of a control circuit, wherein upon detection of an animal, the animal deterring device activates an alarm and/or a light for the purpose of scaring the animal away. In some embodiments a camera is further included, wherein the camera takes pictures or video in order to allow the user to determine what type of animal is in the area. The housing can be mounted on a support object, such as a tree or fence, or can be positioned on a tripod.

### CROSS REFERENCE TO RELATED APPLICATION

This application claims the benefit of U.S. Provisional Application No. 62/269,144 filed on Dec. 18, 2015. The above identified patent application is herein incorporated by reference in its entirety to provide continuity of disclosure.

### BACKGROUND OF THE INVENTION

Field of the Invention

The present invention relates to animal deterring devices. More specifically, the present invention provides an animal deterring device comprising a motion detector for detecting the presence of an animal and a light and alarm unit for scaring the animal away from the area in which the animal deterring device is located.

Various wild animals can wander onto a person's property, creating a variety of problems. Some animals, such as deer may eat plants and crops, causing the owner to lose some of their crops. Other animals, such as bears are dangerous and can pose a risk to people in the area. Thus, many property owners take precautions in order to prevent animals from coming onto their property.

Currently, it can be difficult to try to keep animals away from a person's property. It can be impractical to install fences around a person's entire property and the fences may be ineffective in keeping out larger animals. Further, it is preferable to avoid using devices that may harm an animal should the owner simply wish to scare the animal away.

Devices have been disclosed in the prior art that relate to animal deterring devices. These include devices that have been patented and published in patent application publications. These devices generally relate to animal deterring devices, such as U.S. Published Patent Application No. 2014/0299071, U.S. Pat. No. 8,054,186, U.S. Pat. No. 5,892,446, and U.S. Pat. No. 7,268,689.

These prior art devices have several known drawbacks. These devices fail to allow a user to customize the operation of the animal deterring device for use in deterring any of a variety of wild animals from entering a specific outdoor location, such as the user's backyard or garden. The prior art devices cannot be customized so as to deter a specific type of animal and do not allow the user to capture an image or video of the animal.

In light of the devices disclosed in the prior art, it is submitted that the present invention substantially diverges in design elements from the prior art and consequently it is clear that there is a need in the art for an improvement to existing animal deterring devices. In this regard the instant invention substantially fulfills these needs.

### SUMMARY OF THE INVENTION

In view of the foregoing disadvantages inherent in the known types of animal deterring devices now present in the prior art, the present invention provides a new animal deterring device wherein the same can be utilized for providing convenience for the user when scaring animals away from the user's property or other area.

The present invention provides an animal deterring device for keeping animals away from a specific area, such as a garden, lawn, or other area of the user's property. The animal deterring device comprises a housing having a motion detector thereon for detecting an animal in the nearby area. If an animal is detected, a control circuit causes an alarm unit, a light, and/or a camera to activate so as to scare away the animal, wherein the camera takes a picture or video of the animal to allow the user to determine what type of animal is in the area.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a front perspective view of an embodiment of the animal deterring device.

FIG. 2 shows a rear perspective view of an embodiment of the animal deterring device.

FIG. 3 shows a schematic diagram of the components of the control circuit of the animal deterring device.

### DETAILED DESCRIPTION OF THE INVENTION

Reference is made herein to the attached drawings. Like reference numerals are used throughout the drawings to depict like or similar elements of the animal deterring device. For the purposes of presenting a brief and clear description of the present invention, the preferred embodiment will be discussed as used for scaring animals away from a specific area, such as a garden, lawn, or other area of the user's property. The figures are intended for representative purposes only and should not be considered to be limiting in any respect.

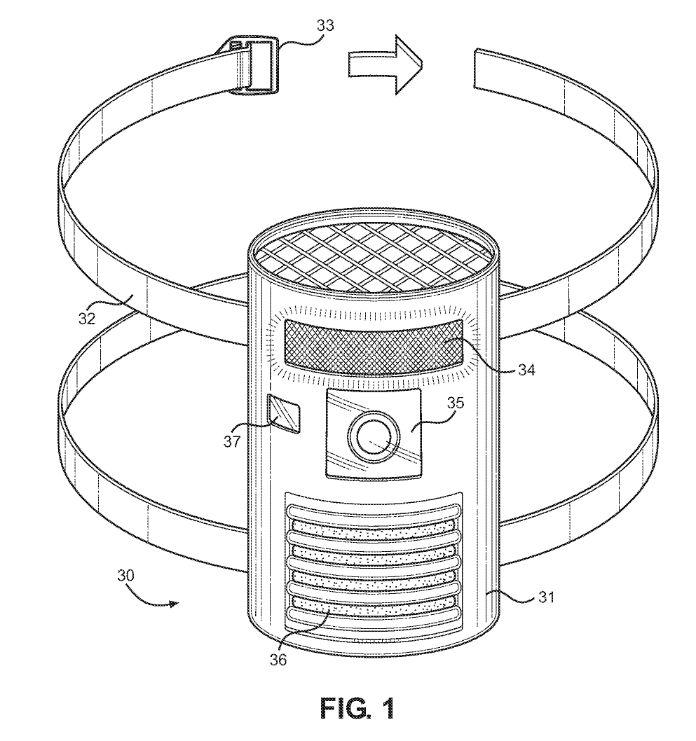

Referring now to FIG. 1, there is shown a front perspective view of an embodiment of the animal deterring device. The animal deterring device 30 comprises a housing 31. The housing 31 is shown as having a cylindrical shape, however, in alternate embodiments, the housing 31 may have alternate shapes or configurations. In the illustrated embodiment, the housing 31 comprises one or more straps 32 thereon that can be used to fasten the housing 31 to a support object, such as a tree, fencepost, or the like. The straps 32 preferably include adjustable fasteners 33 for adjusting the tightness of the straps 32 around the support object. The straps 32 can be adjustably fastened around an object to install the housing 31 thereon. In alternate embodiments, the housing 31 is disposed on a tripod or other support that allows the housing 31 to stand freely within the use of a support surface or object.

The housing 31 comprises a motion detector 36 thereon that is adapted to detect the motion of an animal in the nearby area. The motion detector 36 is preferably an optical motion sensor, however, in alternate embodiments other types of motion detectors 36 are used. The motion detector 36 is calibrated such that the motion detector 36 is not activated by small events such as the wind blowing leaves or branches or by precipitation. The motion detector 36 is preferably able to detect motion within a predetermined range thereof, such as fifty feet.

The housing 31 further includes a light source 37 thereon adapted to produce a bright light to scare an animal away. Further, a camera 35 is provided for taking a picture or video of the animal so that the user can see what kind of animal is in the area. Further, the housing 31 comprises an alarm unit 34 thereon that includes a speaker adapted to produce a loud alert, tone, or siren in order to scare the animal away. In some embodiments, the alarm unit 34 further includes a memory on which an alert or message is stored.

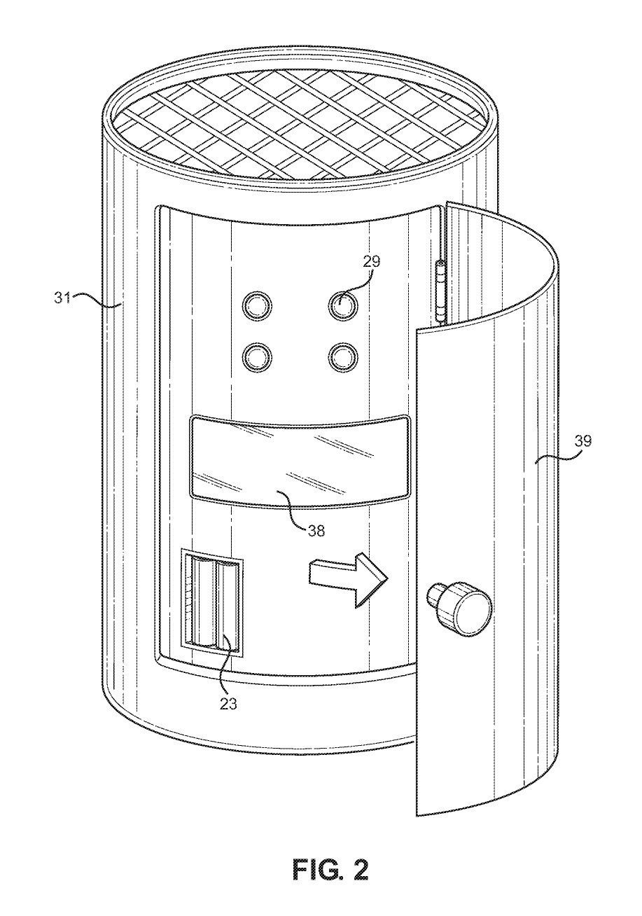

Referring now to FIG. 2, there is shown a rear perspective view of an embodiment of the animal deterring device. The housing 31 further includes a door 39 thereon that covers a control panel. The control panel includes one or more controls 29 thereon for allowing the user to adjust the settings of the animal deterring device. The control panel includes a display 38 thereon for displaying information related to the settings and status of the animal deterring device 30. Further, a power source 23 such as one or more batteries is disposed on the control panel, wherein the power source is used to provide power to the light, camera, motion detector, and alarm unit. In alternate embodiments, the power source 23 can include a connection to an electrical grid, wherein one or more batteries are used as a back-up power source. It is not desired to limit the invention to a particular power source, and any of various power sources may be used.

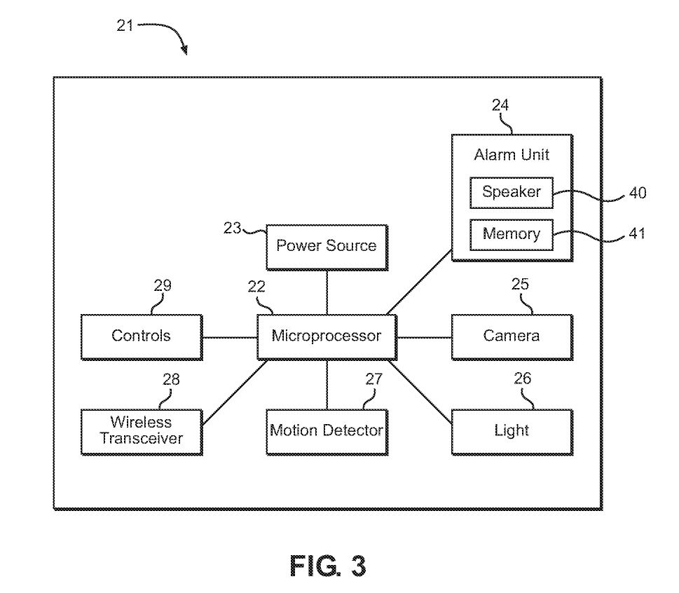

Referring now to FIG. 3, there is shown a schematic diagram of the components of the control circuit of the animal deterring device. The animal deterring device comprises a control circuit 21 having a motion detector 27 adapted to detect an animal in the nearby area. The motion detector 27 is operably connected to a microprocessor 22 that sends a signal to an alarm unit 24 having a speaker 40 when the motion detector 27 detects movement. The alarm unit 24 includes a memory 41 on which one or more tones or sounds are stored, wherein the alarm unit 24 is adapted to produce play one of the stored tones in order to scare away the animal. In some embodiments, the memory 41 of the alarm unit 24 includes a plurality of high-pitched or ultra-sonic frequency tones, wherein each frequency is specifically selected for deterring a specific type of animal. In this way, the user can tailor the use of the animal deterring device for deterring specific animals. The alarm unit 24 is activated for a predetermined amount of time, such as for one minute in order to scare away the animal. One or more controls 29 on the control panel are connected to the microprocessor 22 for adjusting the settings of the animal deterring device such as the loudness of the speaker or the type of sound played. Further, the controls 29 can be used to deactivate the animal deterring device.

In some embodiments, the control circuit further comprises a wireless transceiver 28 adapted to wirelessly communicate with a user's mobile electronic device, such as a smartphone or tablet. This allows the user to control the animal deterring device remotely and also allows the user to check on the status of the animal deterring device.

In other embodiments, the control circuit further comprises a light 26 that is adapted to illuminate when the motion detector 27 detects motion, wherein the light will scare the animal away and will encourage the animal to run away from the animal deterring device. Further, some embodiments further include a camera 25 that is adapted to be activated upon detection of an animal. The camera 25 can take pictures and/or videos of the animal to allow the user to determine what type of animal is in the area. The user can then take additional precautions or steps to ward off that type of animal.

The animal deterring device can be used alone or in conjunction with additional animal deterring devices. In such embodiments, activation of a single animal deterring device activates the other animal deterring devices. The various animal deterring devices are in wireless communication via the wireless transceivers 28 thereof. In an alternate embodiment, the animal deterring devices communicate via a wired connection. This helps to prevent the animal from running away from a first animal deterring device towards another area of the user's property.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) An animal deterring device, comprising:
a control circuit comprising a motion detector adapted to detect an animal in the vicinity of the motion detector, wherein the motion detector is operably connected to a microprocessor and an alarm unit, wherein the alarm unit is configured to produce an audible alert when the motion detector detects an animal.

2) The animal deterring device of claim 1, wherein the control circuit further comprises a camera that is adapted to activate when the motion detector detects an animal.

3) The animal deterring device of claim 1, wherein the control circuit further comprises a light that illuminates when the motion detector detects an animal.

4) The animal deterring device of claim 1, wherein the motion detector is an optical motion sensor.

5) The animal deterring device of claim 1, wherein the control circuit is disposed within a housing, the housing having one or more straps adapted to secure the housing to a support structure.

6) The animal deterring device of claim 5, wherein the housing comprises a control panel having one or more controls thereon, wherein the controls are operably connected to the control circuit.

7) The animal deterring device of claim 1, wherein the control circuit further comprises a wireless transceiver thereon adapted to wirelessly communicate with a mobile electronic device.

8) The animal deterring device of claim 1, wherein the control circuit further comprises a power source.

9) The animal deterring device of claim 8, wherein the power source is one or more batteries.

10) The animal deterring device of claim 1, wherein the alarm unit comprises a memory and a speaker, the memory having one or more audible alerts stored thereon, wherein the one or more audible alerts adapted to be played via the speaker.

11) An animal deterring device, comprising:
a housing having a motion detector, a light, an alarm unit, and a camera thereon;
a control circuit comprising a microprocessor, wherein the control circuit causes the light to illuminate, the alarm unit to produce an audible alert, and the camera to activate when the motion detector detects motion.
